(19) United States
(12) Patent Application Publication
(10) Pub. No.: US 2014/0060592 A1
(43) Pub. Date: Mar. 6, 2014

(54) CLEANING DEVICE

(71) Applicants: HON HAI PRECISION INDUSTRY CO., LTD., New Taipei (TW); HONG FU JIN PRECISION INDUSTRY (ShenZhen) CO., LTD ., Shenzhen (CN)

(72) Inventors: HAI-FENG PAN, Shenzhen (CN); WEN-LI WANG, Shenzhen (CN); TIAN-FENG HUANG, Shenzhen (CN); HAO-CHUNG LEE, New Taipei (TW)

(73) Assignees: HON HAI PRECISION INDUSTRY CO., LTD., New Taipei (TW); HONG FU JIN PRECISION INDUSTRY (ShenZhen) CO., LTD ., Shenzhen (CN)

(21) Appl. No.: 13/975,598

(22) Filed: Aug. 26, 2013

(30) Foreign Application Priority Data
Aug. 31, 2012 (CN) 201210317883X

(51) Int. Cl. B08B 3/02

(52) U.S. Cl. CPC B08B 3/024
USPC 134/174; 134/172

(57) ABSTRACT

A cleaning device includes a first linearly driving assembly, a second linearly driving assembly, a rotation driving assembly, and a sprayer connected one by one in that order. The first linearly driving assembly drives the second linearly driving assembly, the rotation driving assembly, and the sprayer to move along a first direction. The second linearly driving assembly drives the rotation driving assembly and the sprayer to move along a second direction. The rotation driving assembly rotates the sprayer along an axis perpendicular to the first direction and the second direction.

### BACKGROUND

1. Technical Field

The present disclosure relates to cleaning devices, particular to a cleaning device to clean a surface of a workpiece.

2. Description of Related Art

A workpiece may be covered by a coating for protecting or shielding the workpiece, such as ink may be printed on the workpiece for shielding. In next procedure, the ink on the workpiece needs to be cleaned. The workpiece may be immersed into cleaning solution, so that the ink on the workpiece may be dissolved after a certain period. However, the ink cannot evenly dissolve if unevenly printed on the workpiece, thus some ink may remain on the workpiece. In addition, it takes a lot of time to dissolve the ink, which results to a low cleaning efficiency.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a cleaning device of the present disclosure.

FIG. 2 is a partial, isometric view of the cleaning device shown in FIG. 1.

FIG. 3 is a partial, enlarged side view of the cleaning device in a first state of use shown in FIG. 1.

FIG. 4 is a partial, enlarged side view of the cleaning device in a second state of use shown in FIG. 1.

FIG. 5 is a partial, enlarged side view of the cleaning device in a third state of use shown in FIG. 1.

FIG. 6 is a partial, enlarged side view of the cleaning device in a fourth state of use shown in FIG. 1.

### DETAILED DESCRIPTION

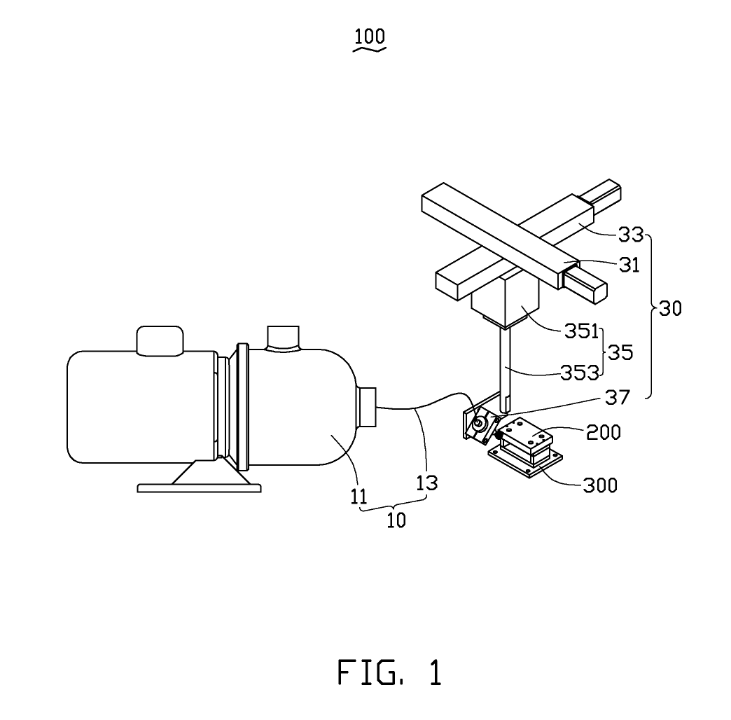

FIG. 1 shows an isometric view of one embodiment of a cleaning device 100, for cleaning an outer surface of a workpiece 200. The cleaning device 100 includes a pressure enhancing mechanism 10, and a cleaning mechanism 30 connected to the pressure enhancing mechanism 10. The pressure enhancing mechanism 10 is configured to enhance a pressure of cleaning solution. The cleaning mechanism 30 is configured to spray high pressure cleaning liquid to the workpiece 200, for cleaning the workpiece 200. In the illustrated embodiment, the workpiece 200 is positioned on a jig 300. The jig 300 and the workpiece 200 are positioned adjacent to the cleaning device 100.

The pressure enhancing mechanism 10 includes a pressure enhancing body 11 and a connecting pipe 13 connected to the pressure enhancing body 11. The pressure enhancing body 11 pumps cleaning solution and enhances a pressure to the cleaning solution. The connecting pipe 13 is connected to the cleaning mechanism 30, and transfers cleaning solution with high pressure to the cleaning mechanism 30. In the illustrated embodiment, the pressure enhancing mechanism 10 is a blower pump connected to the cleaning mechanism 30.

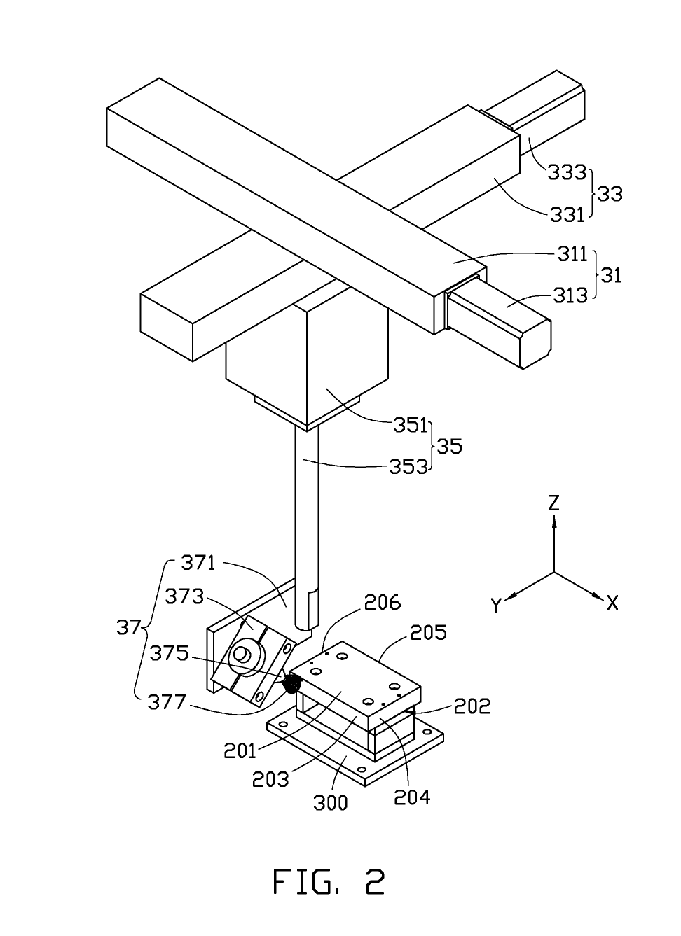

FIG. 2 shows the cleaning mechanism 30. The cleaning mechanism 30 includes a first linearly driving assembly 31, a second linearly driving assembly 33 connected to the first linearly driving assembly 31, a rotation driving assembly 35 connected to the second linearly driving assembly 33, and a spraying assembly 37 connected to the rotation driving assembly 35. The first linearly driving assembly 31 linearly drives the second linearly driving assembly 33, the rotation driving assembly 35, and the spraying assembly 37 to move along a direction defined as an X direction. The second linearly driving assembly 33 linearly drives the rotation driving assembly 35 and the spraying assembly 37 to move along a direction defined as a Y direction. The X direction is substantially perpendicular to the Y direction. The rotation assembly 35 rotates the spraying assembly 37 in a plane substantially parallel to the X direction and the Y direction. The plane that is substantially parallel to the X direction and the Y direction is defined as an XY plane. That is, the rotation assembly 35 rotates the spraying assembly 37 around an axis substantially perpendicular to the X direction and the Y direction. In the illustrated embodiment, the XY plane is substantially horizontal.

The first linearly driving assembly 31 includes a first housing 311, a first driver 313 positioned at an end of the first housing 311, and a first guide screw (blocked by the first housing) received in the first housing 311. The first housing 311 is substantially a hollow rectangular housing, and a longitudinal direction thereof is parallel to the X direction. The first driver 313 is mounted on one end of the first housing 311. The first guide screw is received in the first housing 311 along the longitudinal direction of the first housing 311, and is connected to the first driver 313 and the second linearly driving assembly 33, thus the second linearly driving assembly 33 is connected to the first driver 313 by the first guide screw. The first driver 313 rotates the first guide screw, thereby moving the second linearly driving assembly 33 along the X direction. A structure of the second linearly driving assembly 33 is similar to that of the first linearly driving assembly 31. The second linearly driving assembly 33 includes a second housing 331, a second driver 333 positioned at an end of the second housing 331, and a second guide screw (blocked by the second housing) received in the second housing 331. The second housing 331 is a substantially hollow rectangular housing, and a longitudinal direction is parallel to the Y direction, and is fixed to the first guide screw. The second driver 333 is mounted on one end of the second housing 331. The second guide screw is received in the second housing 331 along the longitudinal direction of the second housing 331, and is connected to the second driver 333 and the rotation driving assembly 35, thus the rotation driving assembly 35 is connected to the second driver 333 by the second guide screw. The second driver 333 rotates the second guide screw, thereby moving the rotation driving assembly 35 along the Y direction. In the illustrated embodiment, the first driver 313 and the second driver 333 are motors.

The rotation driving assembly 35 includes a rotation driver 351 and a rotation shaft 353 connected to the rotation driver 351. The rotation driver 351 is fixed with the second guide screw. An end of the rotation shaft 353 is fixed to an end of the rotation driver 351 away from the second guide screw, and the other end of the rotation shaft 353 is fixed to spraying assembly 37. The rotation driver 351 rotates the rotation shaft 353 around a direction defined as a Z direction. In the illustrated embodiment, the rotation driver 351 is a cylinder.

The spraying assembly 37 includes a connecting plate 371, a fixing plate 373, a sprayer 375, and a restricting member 377. The connecting plate 371 is fixed to a distal end of the rotation shaft 353 away from the rotation driver 351, and is substantially perpendicular to the XY plane. The fixing plate 373 is perpendicularly mounted on the connecting plate 371, and defines an inclined angle relative to the XY plane. In the illustrated embodiment, the fixing plate 373 is an inclined angle of 45 degrees inclined relative to the XY plane. The sprayer 375 is perpendicularly inserted into the fixing plate 373, and is inclined an angle of 45 degrees relative to the XY plane. The sprayer 375 defines a chamber, and connects and communicates with the connecting pipe 13, to receive cleaning solution. The sprayer 375 defines a nozzle 379 at an end away from the fixing plate 373, and the nozzle 379 communicates with the chamber, thus the nozzle 379 communicates with the connecting pipe 13 via the chamber. The nozzle 379 sprays high-pressure rotation of cleaning solution, when the pressure enhancing body 11 enhances a pressure to the cleaning solution. The restricting member 377 is substantially spirally conical, and is fixed on the nozzle 375. A diameter of the restricting member 377 gradually increases along a direction away from the nozzle 379. The restricting member 377 is configured to restrict a spraying range of the nozzle 379.

In assembly, the first guide screw is fixed on the second housing 331, and the second guide screw is fixed to the rotation driver 351. The connecting plate 371 is fixed to the rotation shaft 353, and the fixing plate 373 is mounted on the connecting plate 371. The sprayer 375 is inserted into the fixing plate 373, and defines an angle of 45 degrees relative to the XY plane. The restricting member 377 is mounted on the nozzle 379.

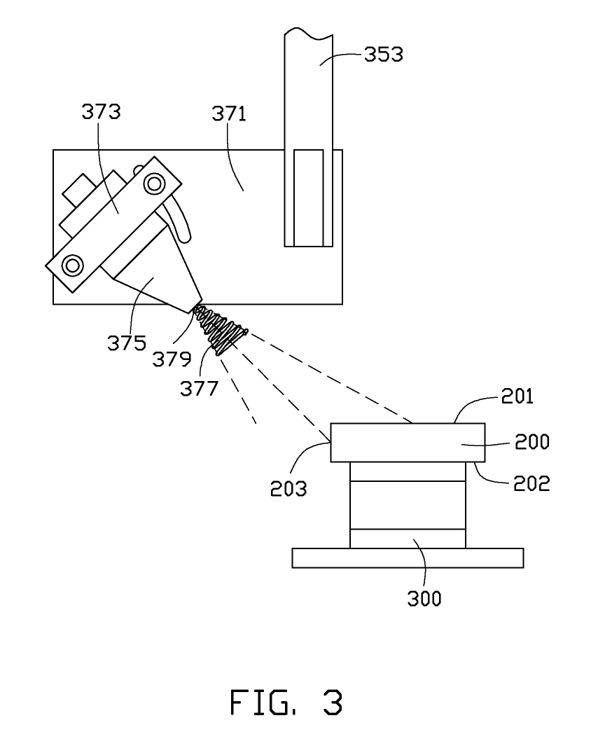

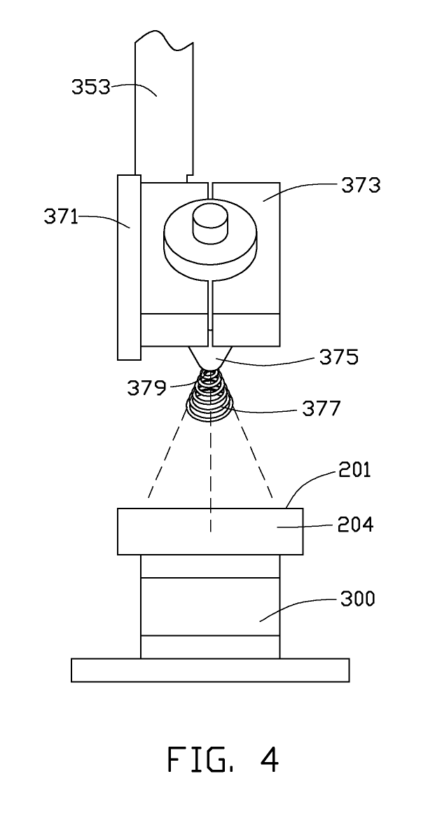

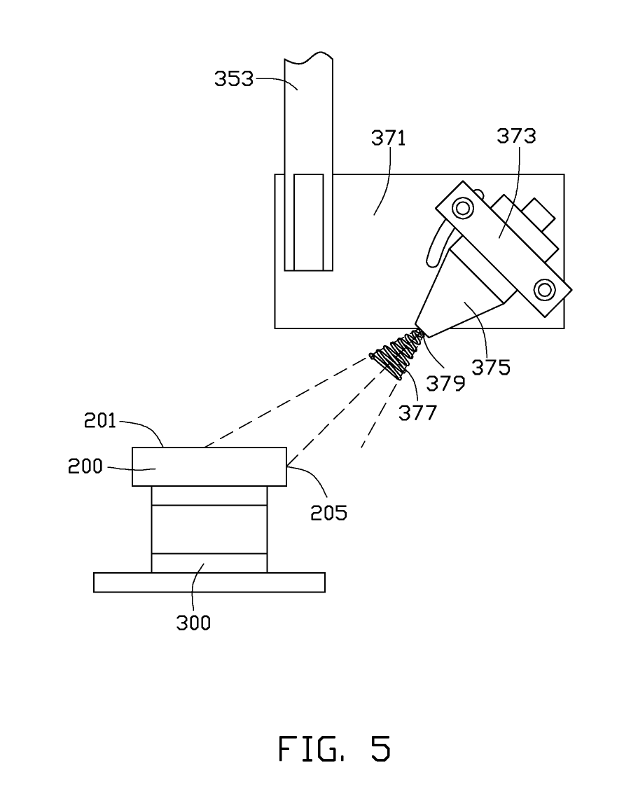

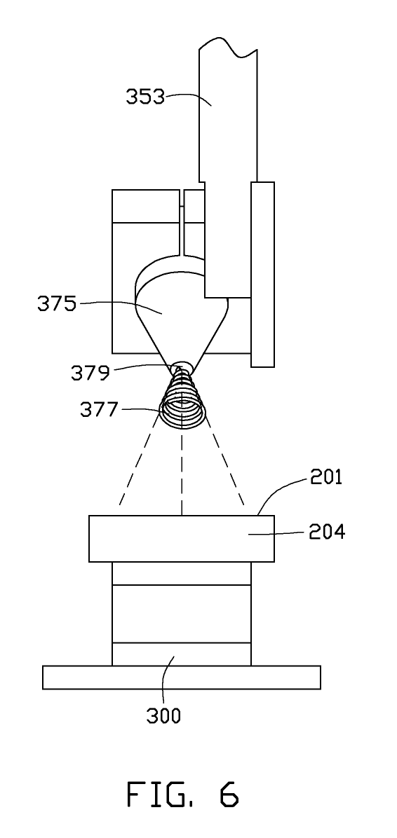

In use, the workpiece 200 is positioned on the jig 300. The outer surface of the workpiece 200 needs to be cleaned, such as the outer surface is coated with ink in the illustrated embodiment. The workpiece 200 is substantially rectangular, and includes a top surface 201, a bottom surface 202, and four side surfaces 203,204,205,206. In a first state of use (shown in FIG. 3), the nozzle 379 is located above workpiece 200, and faces to the top surface 201 and the side surface 203. The sprayer 375 sprays cleaning solution with high-pressure rotation to the top surface 201 and the side surface 206 of the workpiece 200, so that the ink on the top surface 201 and the side surface 203 is dissolved and is sprayed off by the cleaning solution. In a second state of use (shown in FIG. 4). The rotation driver 351 drives the sprayer 375 to rotate 90 degrees, and the first driver 313 and the second driver 333 respectively drives the sprayer 375 to move along the X direction and the Y direction, thus the nozzle 379 finally faces the top surface 201 and the side surface 204. The sprayer 375 sprays cleaning solution with high-pressure rotation to the top surface 201 and the side surface 204 of the workpiece 200, so that the ink on the top surface 201 and the side surface 204 is dissolved and is sprayed off by the cleaning solution. In a third state of use (shown in FIG. 5), the rotation driver 351 drives the sprayer 375 to rotate 90 degrees. The first driver 313 and the second driver 333 respectively drive the sprayer 375 to move along the X direction and the Y direction, thus the nozzle 379 finally faces the top surface 201 and the side surface 205. The sprayer 375 sprays cleaning solution with high-pressure rotation to the top surface 201 and the side surface 205 of the workpiece 200, so that the ink on the top surface 201 and the side surface 205 is dissolved and is sprayed off by the cleaning solution. In a fourth state of use (shown in FIG. 6), the rotation driver 351 drives the sprayer 375 to rotate 90 degrees. The first driver 313 and the second driver 333 respectively drive the sprayer 375 to move along the X direction and the Y direction, thus the nozzle 379 finally faces the top surface 201 and the side surface 206. The sprayer 375 sprays cleaning solution with high-pressure rotation to the top surface 201 and the side surface 206 of the workpiece 200, so that the ink on the top surface 201 and the side surface 206 is dissolved and is sprayed off by the cleaning solution.

In an alternative embodiment, the connecting plate 371 and the fixing plate 373 can be omitted, and thus the sprayer 375 is directly mounted on the rotation shaft 353.

The first linearly driving assembly 31 and the second linearly driving assembly 33 can be other driving structures, such as using a cylinder linearly driving a rod. The rotation driving assembly 25 can be replaced with a motor.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A cleaning device, comprising:
a first linearly driving assembly;
a second linearly driving assembly connected to the first linearly driving assembly;
a rotation driving assembly connected to the second linearly driving assembly; and
a sprayer mounted on the rotation driving assembly, to spray cleaning solution,
wherein the first linearly driving assembly moves the second linearly driving assembly, the rotation driving assembly and the sprayer along a first direction, the second linearly driving assembly moves the rotation driving assembly and the sprayer along a second direction, the second direction is substantially perpendicular to the first direction, the rotation driving assembly rotates the sprayer, the sprayer is driven by the first linearly driving assembly, the second linearly driving assembly and the rotation driving assembly, thus the sprayer is capable of adjustably facing different surfaces of a workpiece, for spraying cleaning solution to and cleaning the different surfaces of the workpiece.

2. The cleaning device of claim 1, further comprising a pressure enhancing mechanism, the pressure enhancing mechanism comprising a pressure enhancing body and a connecting pipe connected to the pressure enhancing body, wherein the connecting pipe is connected to the sprayer, the pressure enhancing body pumps cleaning solution and enhances a pressure to the cleaning solution, the connecting pipe transfers cleaning solution with high pressure to the sprayer, and the sprayer sprays cleaning solution to the workpiece.

3. The cleaning device of claim 1, wherein the sprayer is inclined an angle of about 45 degrees relative to the workpiece.

4. The cleaning device of claim 1, further comprising a fixing plate, wherein the sprayer is inserted into the fixing plate, the fixing plate is connected to the rotation driving assembly, and is inclined relative to the rotation driving assembly.

5. The cleaning device of claim 4, further comprising a connecting plate, wherein the fixing plate is fixed to the connecting plate, the connecting plate is mounted on the rotation driving assembly, and is inclined relative to the rotation driving assembly.

6. The cleaning device of claim 1, wherein the sprayer is hollow for receiving cleaning solution, and comprises a nozzle for spraying cleaning solution.

7. The cleaning device of claim 6, further comprising a restricting member mounted on the nozzle, wherein the nozzle is substantially spirally conical, and a diameter of the restricting member gradually increases along a direction away from the nozzle.

8. The cleaning device of claim 1, wherein the first linearly driving assembly comprises a first housing and a first driver positioned at an end of the first housing, the second linearly assembly is connected to the first driver, and the first driver drives the second linearly assembly to move along the first direction.

9. The cleaning device of claim 8, wherein the second linearly driving assembly comprises a second housing and a second driver positioned at an end of the second housing, the second housing is connected to the first driver, the rotation driving assembly is connected to the second driver, and the second driver drives the rotation driving assembly to move along the second direction.

10. The cleaning device of claim 9, wherein the rotation driving assembly comprises a rotation driver and a rotation shaft connected to the rotation driver, the rotation driver is connected to the second driver, the sprayer is connected to an end of the rotation shaft away from the rotation driver, and the rotation driver rotates the rotation shaft and the sprayer.

11. A cleaning device, comprising:
a first linearly driving assembly;
a second linearly driving assembly connected to the first linearly driving assembly;
a rotation driving assembly connected to the second linearly driving assembly; and
a sprayer mounted on the rotation driving assembly, to spray cleaning solution,
wherein the first linearly driving assembly moves the second linearly driving assembly, the rotation driving assembly and the sprayer along a first direction, the second linearly driving assembly moves the rotation driving assembly and the sprayer along a second direction, the rotation driving assembly rotates the sprayer about an axis substantially perpendicular to the first direction and the second direction.

12. The cleaning device of claim 11, further comprising a pressure enhancing mechanism, the pressure enhancing mechanism comprising a pressure enhancing body and a connecting pipe connected to the pressure enhancing body, wherein the connecting pipe is connected to the sprayer, the pressure enhancing body pumps cleaning solution and enhances a pressure to the cleaning solution, the connecting pipe transfers high pressure cleaning solution to the sprayer, and the sprayer sprays cleaning solution with high-pressure rotation.

13. The cleaning device of claim 11, wherein the sprayer is inclined an angle of about 45 degrees relative to a plane perpendicular to the first direction and the second direction.

14. The cleaning device of claim 11 further comprising a fixing plate, wherein the sprayer is inserted into the fixing plate, the fixing plate is connected to the rotation driving assembly, and is inclined relative to the rotation driving assembly.

15. The cleaning device of claim 11 further comprising a connecting plate, wherein the fixing plate is fixed to the connecting plate, the connecting plate is mounted on the rotation driving assembly, and is inclined relative to the rotation driving assembly.

16. The cleaning device of claim 11, wherein the sprayer is hollow for receiving cleaning solution, and comprises a nozzle for spraying cleaning solution.

17. The cleaning device of claim 16 further comprising a restricting member mounted on the nozzle, wherein the nozzle is substantially spirally conical, and a diameter of the restricting member gradually increases along a direction away from the nozzle.

18. The cleaning device of claim 11, wherein the first linearly driving assembly comprises a first housing and a first driver positioned at an end of the first housing, the second linearly assembly is connected to the first driver, and the first driver drives the second linearly assembly to move along the first direction.

19. The cleaning device of claim 18, wherein the second linearly driving assembly comprises a second housing and a second driver positioned at an end of the second housing, the second housing is connected to the first driver, the rotation driving assembly is connected to the second driver, and the second driver drives the rotation driving assembly to move along the second direction.

20. The cleaning device of claim 19, wherein the rotation driving assembly comprises a rotation driver and a rotation shaft connected to the rotation driver, the rotation driver is connected to the second driver, the sprayer is connected to an end of the rotation shaft away from the rotation driver, and the rotation driver rotates the rotation shaft and the sprayer.
